(19) United States
(12) Patent Application Publication
(10) Pub. No.: US 2008/0192029 A1
(43) Pub. Date: Aug. 14, 2008

(54) Passive circuits for de-multiplexing display inputs

(76) Inventors: Michael Hugh Anderson, Leucadia, CA (US); Franklin Antonio, Del Mar, CA (US); Sameer Wadhwa, San Diego, CA (US)

Correspondence Address: KNOBBE, MARTENS, OLSON & BEAR, LLP, 2040 MAIN STREET, FOURTEENTH FLOOR, IRVINE, CA, 92614, US

(21) Appl. No.: 11/704,450

(22) Filed: Feb. 8, 2007

(51) Int. Cl. G06F 3/038

(52) U.S. Cl. 345/204

(57) ABSTRACT

A display array which can reduce the row connections between the display and the driver circuit and methods of manufacturing and operating the same are disclosed. In one embodiment, a display device comprises an array of microelectromechanical system (MEMS) display elements and a plurality of passive impedance network circuits coupled to said array and configured to provide row output voltages to drive said array. Each passive impedance network comprises an output to a row of display elements and three or more inputs. No more than one input is shared by two passive impedance networks.

### BACKGROUND OF THE INVENTION

1. Field of the Invention

The field of the invention relates to microelectromechanical systems (MEMS).

2. Description of the Related Technology

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical voltage. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY OF CERTAIN EMBODIMENTS

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other display devices.

In one embodiment, a display device comprises an array of microelectromechanical system (MEMS) display elements; and a plurality of passive impedance network circuits coupled to said array and configured to provide row output voltages to drive said array, each passive impedance network comprising an output to a row of display elements and three or more inputs; wherein for each passive impedance network the output is controlled by the three or more inputs, and wherein each input at one of two pre-determined voltages.

In another embodiment, a display device comprises an array of microelectromechanical system (MEMS) display elements; and a plurality of passive impedance network circuits coupled to said array and configured to provide row output voltages to drive said array, each passive impedance network comprising an output to a row of display elements and three or more inputs; wherein each passive impedance network circuit shares no more than one input with any other passive impedance network circuit.

In another embodiment, a display device comprises means for displaying image data, and means for demultiplexing one or more row driving voltages and providing demultiplexed voltages to said displaying means.

In another embodiment, a method of making a display device comprises forming an array of microelectromechanical system (MEMS) display elements on a substrate; and forming a plurality of passive impedance network circuits coupled to said array and configured to provide row output voltages to drive said array, each passive impedance network comprising an output to a row of display elements and three or more inputs, wherein for each passive impedance network the output is controlled by the three or more inputs, and wherein each input is at one of two pre-determined voltages.

In another embodiment, a method of making a display device comprises forming an array of microelectromechanical system (MEMS) display elements on a substrate; and forming a plurality of passive impedance network circuits coupled to said array and configured to provide row output voltages to drive said array, each passive impedance network comprising an output to a row of display elements and three or more inputs; wherein the plurality of passive impedance network circuits are connected to each other in a manner such that each passive impedance network circuit shares no more than one input with any other passive impedance network circuit.

In another embodiment, a method of demultiplexing a row driving voltage in a row by row addressing scheme of a display device comprises applying a first control voltage to a first set of output nodes including a selected output node through a first set of series impedances; applying a second control voltage to a second set of output nodes through a second set of series impedances, said second set including said selected output node and not including any other output nodes of said first set; and applying a third control voltage to a third set of output nodes through a third set of series impedances, said third set including said selected output node and not including any other output nodes of said first set or said second set.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIG. 5A illustrates one exemplary frame of display data in the 3×3 interferometric modulator display of FIG. 2.

FIG. 5B illustrates one exemplary timing diagram for row and column voltages that may be used to write the frame of FIG. 5A.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 is a system block diagram illustrating one embodiment of an electronic device incorporating a display array and a demultiplexer which reduces the row input lines to the display.

FIG. 9 illustrates an embodiment of a 3-terminal resistor star used in the demultiplexer shown in FIG. 8.

FIG. 10 is a schematic diagram illustrating an embodiment of the demultiplexer shown in FIG. 8.

FIG. 11 is a timing diagram illustrating a series of voltages applied to the demultiplexer in FIG. 10 and the resulting voltages applied to rows of the display.

FIG. 12 illustrates how to connect the array of resistor stars in the demultiplexer of FIG. 10 for any value of n.

FIG. 13 is a schematic diagram illustrating another embodiment of the demultiplexer.

### DETAILED DESCRIPTION OF THE CERTAIN EMBODIMENTS OF THE INVENTION

The following detailed description is directed to certain specific embodiments of the invention. However, the invention can be embodied in a multitude of different ways. In this description, reference is made to the drawings wherein like parts are designated with like numerals throughout. As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

For certain embodiments of a display device, it is desirable to reduce the number of row connections required between the display and the driver circuit. For example, in a display device incorporated in mobile applications, the display driver can be a significant fraction of the overall display module cost. The cost is often directly related to the number of connections required between the driver circuit and the display. Reducing the number of row connections required between the display array and the driver circuit is preferred because it leads to lower electronics cost, can reduce routing circuitry on the display substrate, as well as provide other benefits. In one embodiment, a circuit including an arrangement of 3-resistor nodes is used to de-multiplex a number of input signals into a larger number of output signals. One of the output signals (the selected output) is applied to a row such that pixels of that row may be updated with image data. All remaining signals (the unselected outputs) are applied to other rows such that their pixels remain unchanged. The selected output has a maximum absolute value while the magnitude of the unselected outputs is less than, for example, ⅓ of the maximum.

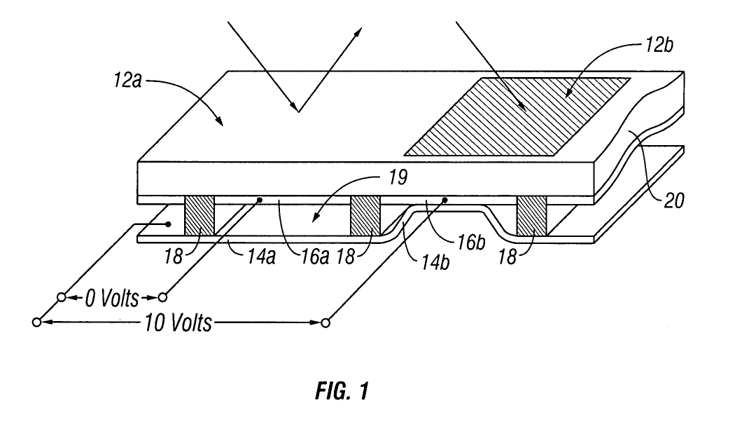

One interferometric modulator display embodiment comprising an interferometric MEMS display element is illustrated in FIG. 1. In these devices, the pixels are in either a bright or dark state. In the bright (“on” or “open”) state, the display element reflects a large portion of incident visible light to a user. When in the dark (“off” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical cavity with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise of several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the cavity 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

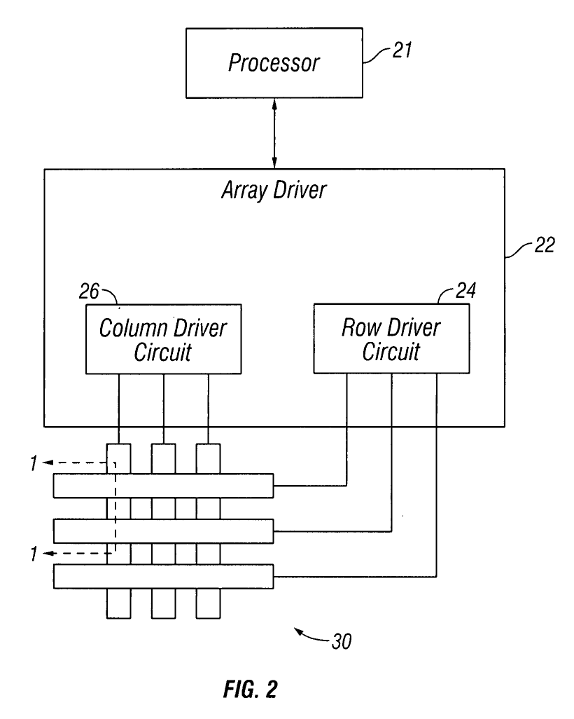

FIGS. 2 through 5B illustrate one exemplary process and system for using an array of interferometric modulators in a display application.

FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital voltage processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

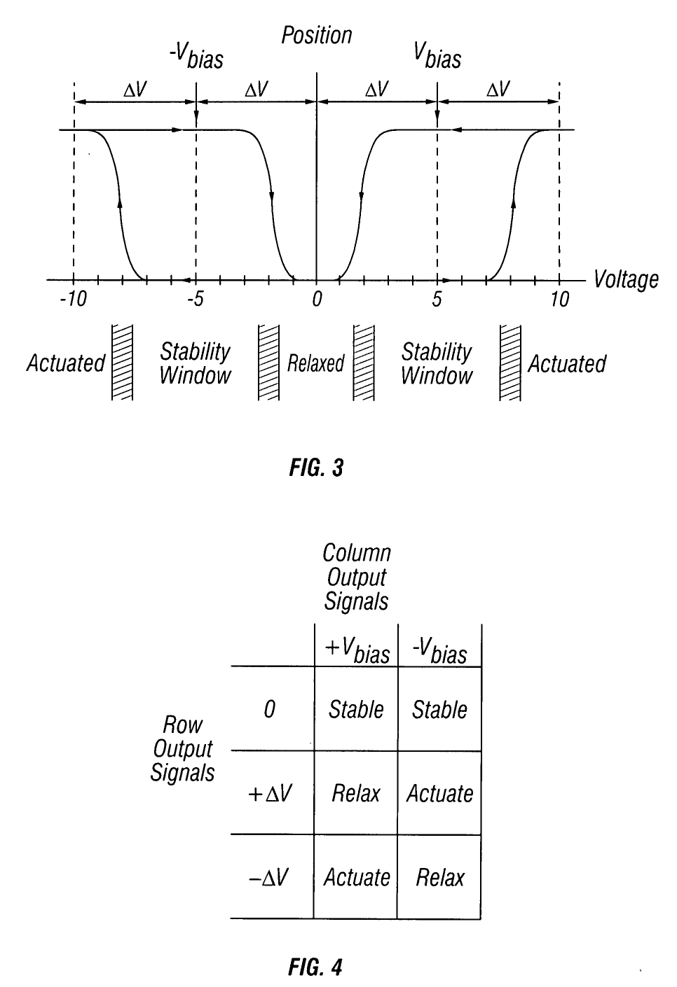

In one embodiment, the processor 21 is also configured to communicate with an array driver 22. In one embodiment, the array driver 22 includes a row driver circuit 24 and a column driver circuit 26 that provide voltages to a display array or panel 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the Row 1 electrode, actuating the pixels corresponding to the asserted column lines. The asserted set of column electrodes is then changed to correspond to the desired set of actuated pixels in the second row. A pulse is then applied to the Row 2 electrode, actuating the appropriate pixels in Row 2 in accordance with the asserted column electrodes. The Row 1 pixels are unaffected by the Row 2 pulse, and remain in the state they were set to during the Row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

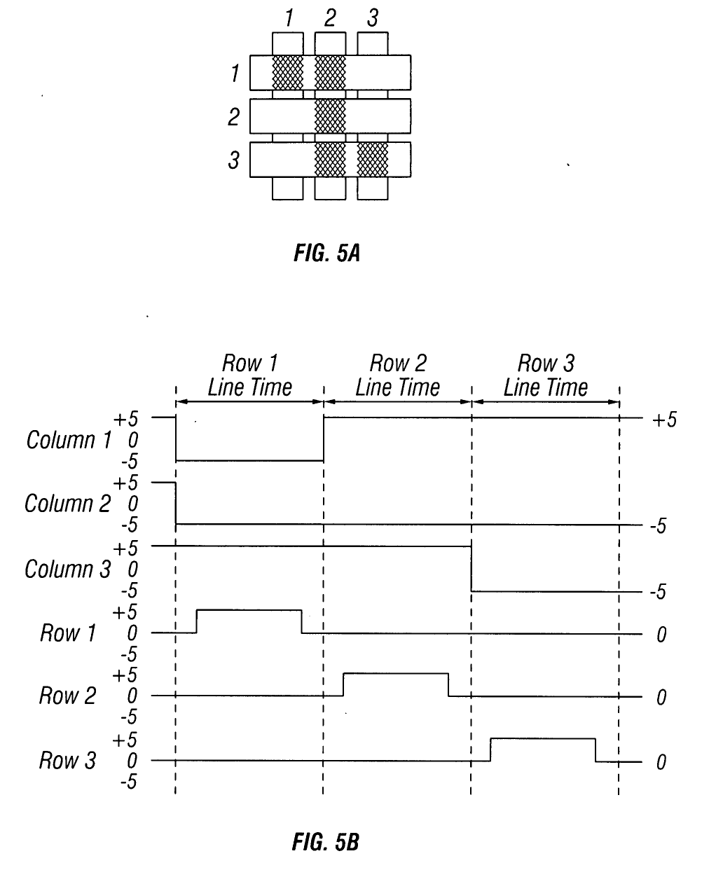

FIGS. 4, 5A, and 5B illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, it will be appreciated that voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column voltages applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for Row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set Row 2 as desired, column 2 is set to −5 volts, and columns 1 and 3 are set to +5 volts. The same strobe applied to Row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The Row 3 strobe sets the Row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

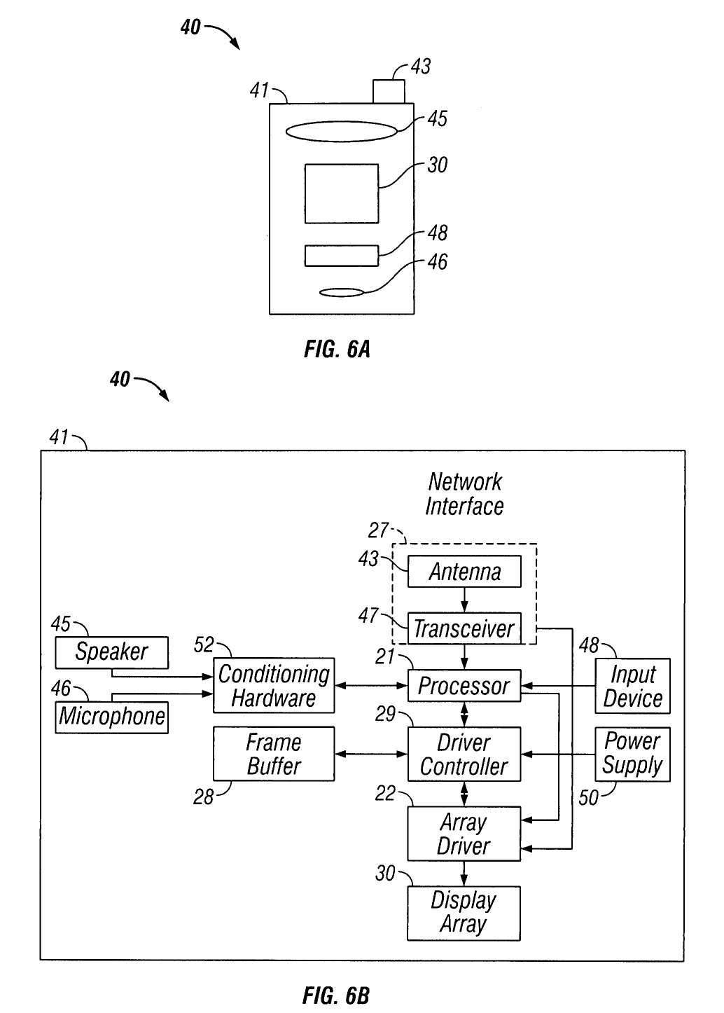

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 44, an input device 48, and a microphone 46. The housing 41 is generally formed from any of a variety of manufacturing processes as are well known to those of skill in the art, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device, as is well known to those of skill in the art. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a voltage (e.g. filter a voltage). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the processor 21. The antenna 43 is any antenna known to those of skill in the art for transmitting and receiving voltages. In one embodiment, the antenna transmits and receives RF voltages according to the IEEE 802.11 standard, including IEEE 802.11(a), (b), or (g). In another embodiment, the antenna transmits and receives RF voltages according to the BLUETOOTH standard. In the case of a cellular telephone, the antenna is designed to receive CDMA, GSM, AMPS or other known voltages that are used to communicate within a wireless cell phone network. The transceiver 47 pre-processes the voltages received from the antenna 43 so that they may be received by and further manipulated by the processor 21. The transceiver 47 also processes voltages received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting voltages to the speaker 45, and for receiving voltages from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. Those of skill in the art will recognize that the above-described optimization may be implemented in any number of hardware and/or software components and in various configurations.

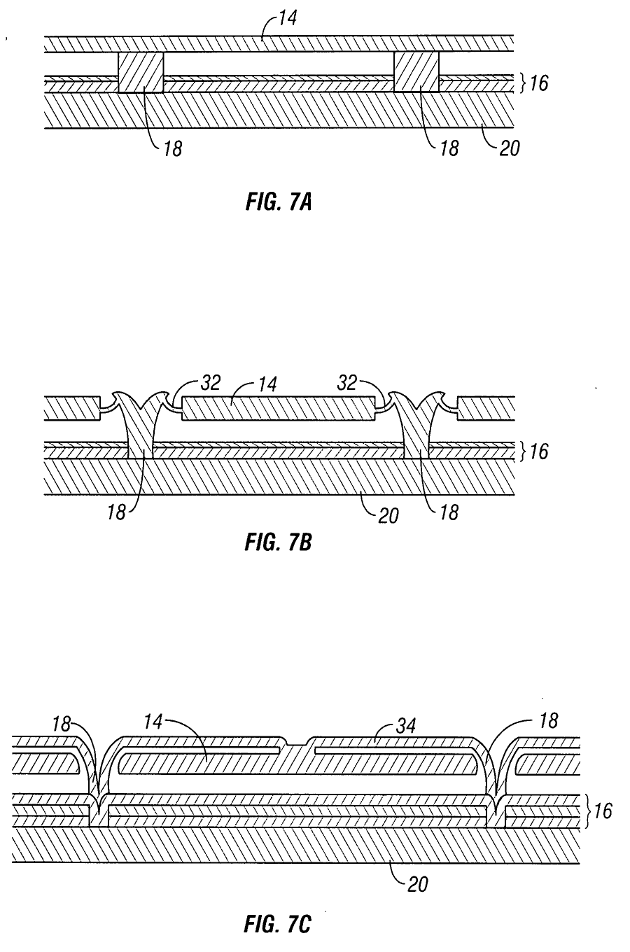

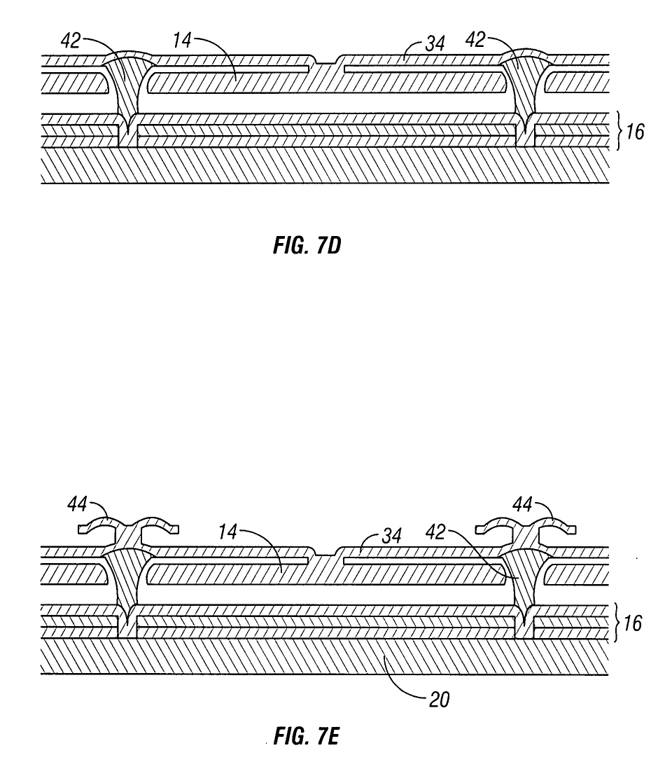

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 is attached to supports at the corners only, on tethers 32. In FIG. 7C, the moveable reflective layer 14 is suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the cavity, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows voltage routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. Such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

As discussed above, the interferometric modulator is driven by the difference between the row and column voltages. It will be appreciated that the terms “columns” and “rows” are geometrically arbitrary in the sense that either can be oriented in the vertical or horizontal direction. In this disclosure, the “columns” will be considered the set of display inputs receiving voltages that are image data dependent. The “rows” will be considered to be the set of display inputs receiving voltages that do not vary with the image data, such as the sequential row strobe input voltages described above.

For certain embodiments of a display device, it is desirable to reduce the number of row connections required between the display and the driver circuit. For example, a display with color pixels may have three times as many columns and four times as many rows as a black and white display with the same number of pixels. In these color embodiments, each pixel may comprise four red, four blue, and four green modulators. The reflective states of the set of 12 “sub-pixels” determine the perceived color of the pixel as a whole. As a result, four times as many row driver outputs would normally be necessary. It is then preferable to drive such a display with a driver circuit that has fewer row driving lines. In certain embodiments of a display device incorporated in mobile applications, the display driver can be a significant fraction of the overall display module cost. The cost is often directly related to the number of connections required between the driver circuit and the display. Reducing the number of row connections required between the display array and the driver circuit is preferred because it leads to lower electronics cost.

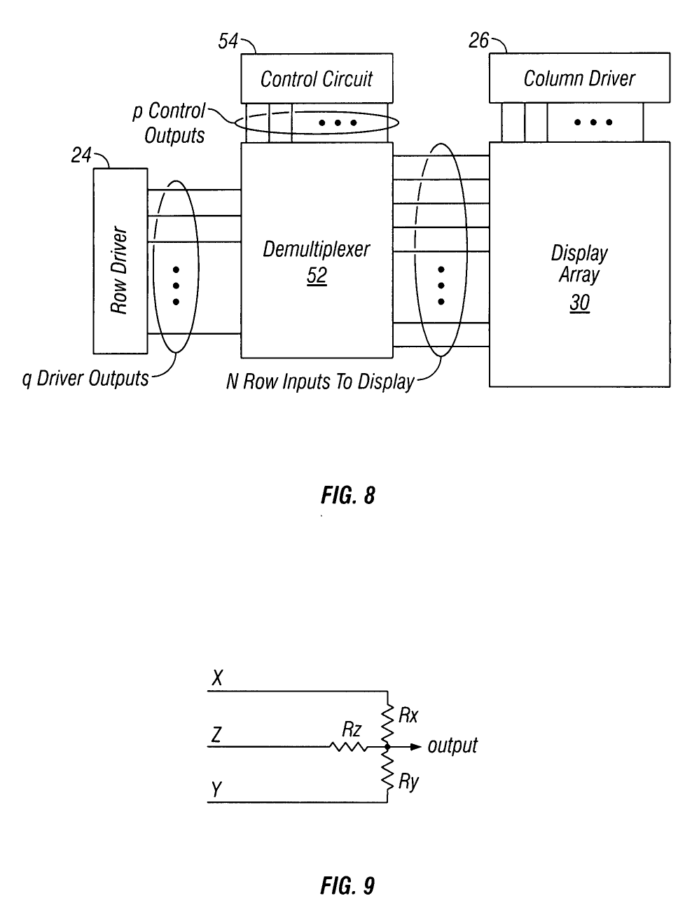

FIG. 8 is a system block diagram illustrating one embodiment of an electronic device incorporating a display array and a demultiplexer which reduces the row input lines to the display. In this figure, the N row voltages for the display array are produced by a demultiplexer 52 that has as inputs the row driver output voltages and a separate set of control voltages produced by a control circuit 54. As shown in FIG. 8, the display may have N rows, the row driver 24 may have q outputs, and the control circuit 54 may have p outputs. In some advantageous embodiments, the control circuit 54 is implemented as part of the row driver 24. If q+p is significantly less than N, and if the demultiplexer can be manufactured simply and inexpensively next to and/or along with the display array, cost reductions for the system as a whole will result.

In a typical driving scheme for the display, one of the series of rows is selected while the rest of the rows are unselected. The selected row is driven by a voltage such that the pixels in that row are updated with the corresponding image data. The unselected rows are driven by a voltage within the hysteresis loop such that their pixels remain unchanged. This operation is then repeated for the rest of the rows, one at a time, in a sequential fashion to produce the frame. In the embodiment illustrated above with regard to FIGS. 4, 5A, and 5B, the selected row is driven by +5 or −5 volts while the unselected rows are driven by 0 volts.

In the system illustrated in FIG. 8, the demultiplexer may be implemented in many different ways. One type of implementations is based on resistors. Resistor-based demultiplexers may be desirable because of their relatively low cost compared to active switch-based demultiplexers. However, they also may suffer from one or more problems such as leakage current, limited selection ratio, and a complicated control scheme in which multiple voltage levels are required.

The selection ratio is the ratio of the amplitude of the selected output to the largest amplitude of the unselected outputs. The resistor-based demultiplexer typically has some unselected outputs in a “partially on” state having a non-zero output and thus a selection ratio of a finite value. A low selection ratio may render a resistor-based demultiplexer unsuitable for an application. For many display arrays, a selection ratio of no less than 3 can be required. Furthermore, leakage current tends to increase with increasing numbers of partially on outputs and lower selection ratios.

FIG. 9 illustrates an embodiment of a 3-terminal resistor star used in one embodiment of a demultiplexer shown in FIG. 8. The 3-terminal resistor star has three input terminals x, y, and z, and one output terminal. Each input terminal is connected to the output terminal through one of three series resistors, Rx, Ry, and Rz. The resistances of these resistors may vary in relative value, but in one advantageous embodiment, all three resistors have the same resistance.

If all three input terminals are set to the desired output voltage, the output of the star network will be that voltage. If only one of the input terminals is set to the desired output voltage, the output will be a fraction of that voltage depending on resistance of the resistors. For example, if these resistors have the same resistance, the output will be ⅓ of the desired output voltage.

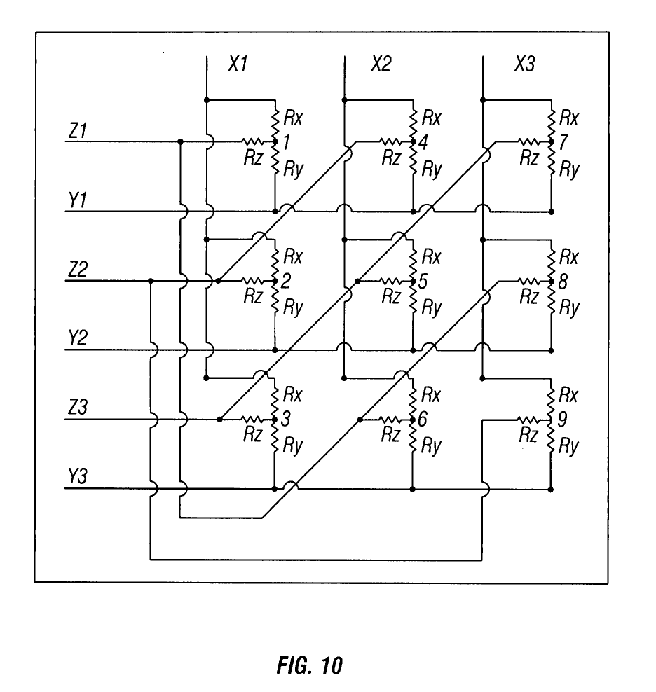

FIG. 10 is a schematic diagram illustrating an embodiment of the demultiplexer shown in FIG. 8, utilizing one 3-terminal resistors star for each of the row outputs. The demultiplexer has three groups of input signals where each group includes n input signals. In the exemplary embodiment, n=3. One of skill in the art will recognize that n can equal integers other than three. The group x includes three signals x1, x2, and x3. The group y and z each includes three signals y1-y3 and z1-z3 respectively. The demultiplexer includes an array of n² (9 since n=3 in the example) resistor nodes. Each resistor node is a 3-terminal resistor star illustrated in FIG. 9. The three input terminals of each resistor star are connected to three input signals, including one from each of the three input signal groups. The output of each resistor star network is connected to a separate row of the display array 30. In the exemplary embodiment, the display array 30 has nine rows, each driven by a resistor star output designated by an integer from 1 to 9. The resistor stars are connected to the x, y, and z inputs in a topology such that each resistor star shares no more than one input signal with any other resistor star.

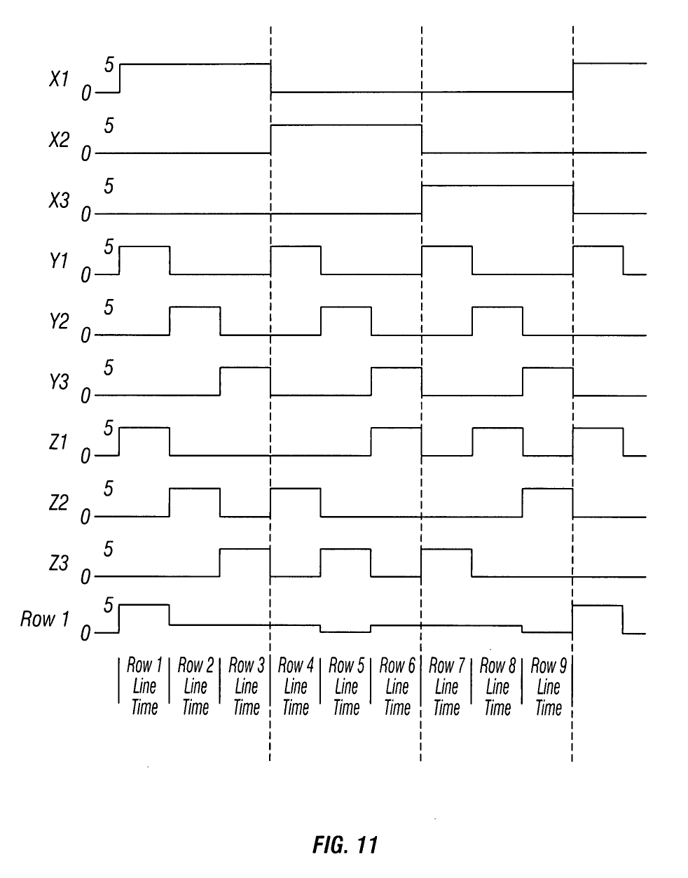

FIG. 11 is a timing diagram illustrating a series of voltages applied to the demultiplexer in FIG. 10 and the resulting voltages applied to rows of the display. To simplify the discussion, only the resulting voltage output for row 1 is illustrated. It is straightforward to extend the illustrated principles to any additional rows. In the exemplary embodiment, each display pixel has the hysteresis characteristics of FIG. 3, wherein each pixel has a 3-7 volt stability window. Each column is set to either +5 volts to actuate a pixel or −5 volts to release a pixel. Each of the input voltages (x1-x3, y1-y3, and z1-z3) is at one of two pre-determined voltages. In one embodiment, the two predetermined voltages are 0 volts (i.e., ground) or +5 volts. For display pixels having different hysteresis characteristics, the embodiment illustrated here may be easily adjusted following the principle disclosed.

At the beginning of a “line time” for Row 1, all three groups of input voltages are at 0 volts. As a result, Rows 1-9 are all at 0 volts. With these applied voltages, all pixels are stable in their existing actuated or relaxed states, with a 5 volt potential difference across each pixel. During line time for Row 1, the input voltages x1, y1, and z1 are all increased to +5 volts while the rest of the input voltages are set to 0 volts. In response, the voltage at Row 1 is at +5 volts. The pixels of Row 1 are subject to a potential difference of zero or 10 volts outside the 3-7 volt stability window, and therefore updated in accordance with the image data applied to the columns.

Since each resistor star shares no more than one input signal with any other resistor star, each of the resistor stars other than the resistor star coupled to Row 1 has no more than one input voltage set to +5 volts. Therefore, the output of these resistor stars, which are coupled to Rows 2-9, is either 0 volts or 1.67 volts. Pixels of Rows 2-9 are therefore within the 3-7 volt stability window and remain unchanged. During the Row 1 line time, Rows 2, 3, 6, 8, 4, and 7 see a voltage of 1.67 during the Row 1 line time, and rows 5 and 9 receive 0 volts.

During line time for Row 2, the row driver output voltage x1 stays at +5 volts. The input voltages for y1 and z1 drop to 0 and the input voltages for y2 and z2 are increased to +5 volts. Similar to the discussion above, pixels in Row 2 are updated as expected while pixels of other rows remain unchanged. By following the approach described above, Rows 3-9 can also be properly updated with different combinations of 2 level row strobe inputs.

In the exemplary driving scheme, one of the three groups of input voltages (x, y, and z) can be thought of as the row driver output voltages of FIG. 8 while the other two groups may be considered the control voltages of FIG. 8. The assignment of a particular group (either x, y, or z) as the row driver output voltages is arbitrary and does not affect the operation of the demultiplexer.

In the exemplary embodiment, the possible voltage levels of the row driver output signal is the same as when no demultiplexer is used. The control voltage also has the same voltage levels. Therefore, control of the demultiplexer does not require the row driver 24 or the control circuit 54 to generate multiple voltage levels or produce a complex multi-level output pattern. In comparison, many existing applications require more voltage levels to be used so that the demultiplexer can work properly. Further, the exemplary embodiment provides a relatively high selection ratio of 3.

Another factor to consider is power dissipation. Among all unselected resistor stars, i.e., resistor stars whose output is not connected to a row being selected, some (also referred to as “partially selected resistor stars”) have one input terminal at +5 volts and the other two input terminals at ground (“0 volts”). There is leakage current associated with these partially selected resistor stars. The power dissipation due to leakage current may be calculated as a function of n and the resistance values. For example, totally 40 mW power is dissipated when each resistor has a resistance of 10 kohm and n equals 9. The power dissipation of this exemplary embodiment is low in comparison to many other solutions.

In the exemplary embodiment with n=3, 9 inputs of the demultiplexer produce 9 outputs. However, this scheme is scalable to any integer number n. 3n inputs of the demultiplexer produce n² outputs, resulting in a reduction ratio of output leads to display rows of 3/n. This reduces the total number of control/driver lines coupled to the display circuit. For example, selecting n=9 allows 27 inputs to generate 81 outputs. Multiple instances of that circuit may be used together to drive, for example, 640 outputs. When n becomes larger, the lead reduction this circuit offers also increases.

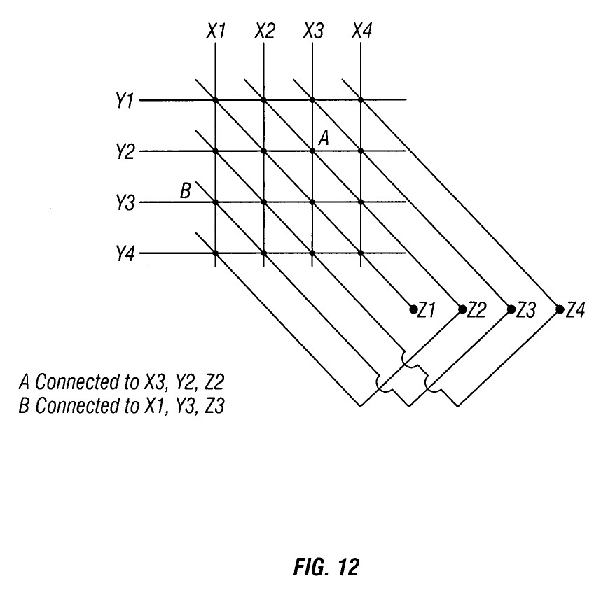

FIG. 12 illustrates how to connect an array of resistor stars for the demultiplexer of FIG. 10 for any value of n. Each node of the 2-d grid represents a resistor star. The first group of signals, x1-x4, is connected to a set of columns while the second group of signals, y1-y4, is connected to a set of rows.

The third group of signals z1-z4 is connected to diagonally related nodes of the array of resistor stars in a step-by-step approach. The signal z1 is connected to the nodes on the diagonal line of the array. The group of nodes to which z2 is connected includes the available nodes located to the right of and most adjacent to the diagonal line and the corner node located to the left of and most distant from the diagonal line. The step described with regard to z2 may be repeated to select a group of nodes for each of the remaining z signals, with the last z input connected to the nodes located to the left of and most adjacent to the diagonal line and the corner node located to the right of and most distant from the diagonal line.

The connections for n=4 is illustrated in FIG. 12. It can be noted, for example, that the nodes connected to x3 do not share any other x or any common y or z signal. This is true for any selected input. Therefore, no pair of nodes shares more than one common input under this connection scheme.

It will be appreciated that voltages of opposite polarity than those described above can be used, e.g., actuating a pixel can involve setting the appropriate column to +5 volts, and the appropriate row to −5 volts. In that case, releasing the pixel is accomplished by setting the appropriate column to −5 volts, and the appropriate row to the same −5 volts, producing a zero volt potential difference across the pixel.

It will also be appreciated that the timing, sequence, and levels of voltages used to perform row and column actuation can be varied widely within the general principles outlined above, and the above example is exemplary only, and any actuation voltage method can be used with the systems and methods described herein.

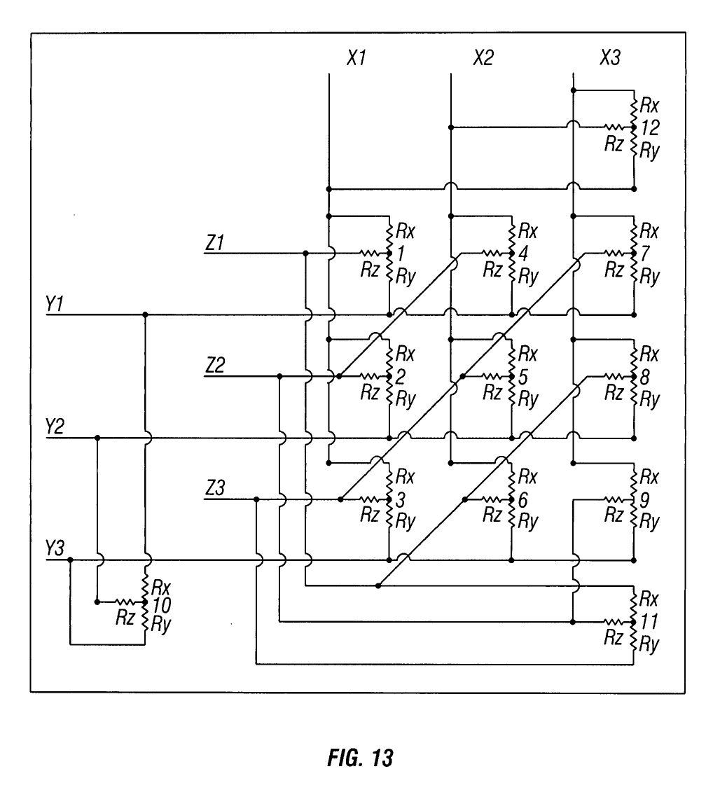

FIG. 13 is a schematic diagram illustrating another embodiment of the demultiplexer. This embodiment adds three more resistor stars to the embodiment illustrated in FIG. 10. The first additional resistor star has all three input terminals connected to three input signals from the same signal group x. The second and the third additional resistor stars each has all three input terminals connected to three input signals from the same signal group y and z respectively. For any integer number n, one or more number of additional resistor stars are added for each signal group such that each additional resistor star connects to three signals within that group and no two additional resistors share more than one input signal.

This revision allows more outputs to be produced for the same number of inputs, thereby further reducing numbers of row connections required. For n=3, there are 3 additional outputs. For n=9, there are 12 additional outputs per signal group, which is totally 36 additional nodes.

More embodiments of a topology that meets this functional requirement may be identified as described as follows. For a demultiplexer having 3n input signals, the topology may be constructed by solving the following problem: find a collection of 3 member subsets of a 3n member set such that every distinct pair of elements of the 3n elements is contained in at most one of these 3 member subsets. The 3n member set corresponds to the 3n input signals. Each 3 member subset corresponds to three input signals connected to a resistor star. Once such a collection is found, the demultiplexer may be constructed by assigning one resistor star for each 3 member subset. A Steiner Triple system, a well-known design in the mathematical world, is a collection of 3 member subsets of an N member set such that every pair of elements of the N member set is contained in exactly one of these 3 member sets where N is either 1 (mod 6) or 3 (mod 6). Any Steiner Triple system with N=3n is a solution to the mathematical problem defined above and therefore corresponds to a topology that meets the functional requirement.

In the foregoing embodiments, each 3-terminal resistor star includes three input terminals, each being connected to the output terminal via a separate series resistor. This embodiment may be revised such that each resistor star now includes 4 input terminals, each terminal being connected to the output terminal via a separate series resistor. Such 4-terminal resistor stars may be connected to each other in a topology such that each 4-terminal resistor star shares no more than one input signal with any other 4-terminal resistor star. This improves the selection ratio from 3 to 4.

A topology satisfying this requirement may be established by stacking n planes of FIG. 12 in a third dimension and connecting each sequence of nodes extending in the third dimension and corresponding to the same 2-D location in each plane with one of a fourth group of signals. In this embodiment, 4n² total input lines produces n³ outputs, resulting in a reduction ratio of 4/n and a selection ratio of 4.

The topologies described herein are not unique, and various other schemes having outputs that share at most one input are possible. Different configurations have different characteristics in terms of selection ratio, leakage current, and lead reduction. The most advantageous will depend on the specific application.

It should be noted that the passive impedance components and networks which form part of the row demultiplexing circuitry of the invention need not have fixed values. In addition, the demultiplexing circuitry need not be totally devoid of active components such as transistors or other types of switches. Although not necessary in many advantageous embodiments, switches may be useful to switch in appropriate impedances at the appropriate times. It may also be advantageous to have resistors of controllable values. This could be accomplished with local resistive heating circuits that could be controlled to raise the resistance of appropriate resistors in the circuits at appropriate times to more closely match the ideal drive and hold voltages for the pixels during the writing process. These embodiments will suffer drawbacks in increased complexity and cost, but may be useful in some instances.

The foregoing description details certain embodiments of the invention. It will be appreciated, however, that no matter how detailed the foregoing appears in text, the invention can be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A display device comprising:
an array of microelectromechanical system (MEMS) display elements; and
a plurality of passive impedance network circuits coupled to said array and configured to provide row output voltages to drive said array, each passive impedance network comprising an output to a row of display elements and three or more inputs,
wherein for each passive impedance network the output is controlled by the three or more inputs, and wherein each input is at one of two pre-determined voltages.

2. The device of claim 1, wherein each passive impedance network comprises a resistor network.

3. The device of claim 1, wherein each passive impedance network is substantially the same.

4. The device of claim 1, wherein each passive impedance network circuit further comprises three or more resistors, each resistor connecting a different one of the inputs to the output.

5. The device of claim 4, wherein the three or more resistors have substantially the same resistance.

6. The device of claim 1, wherein one of the pre-determined voltages is ground.

7. A display device comprising:
an array of microelectromechanical system (MEMS) display elements; and
a plurality of passive impedance network circuits coupled to said array and configured to provide row output voltages to drive said array, each passive impedance network comprising an output to a row of display elements and three or more inputs,
wherein each passive impedance network circuit shares no more than one input with any other passive impedance network circuit.

8. The device of claim 7, wherein the plurality of passive impedance network circuit is arranged according to a Styler Triple system.

9. The device of claim 7, further comprising:
a display;
a processor that is in electrical communication with said display, said processor being configured to process image data; and
a memory device in electrical communication with said processor.

10. The device of claim 9, further comprising a driver circuit configured to send at least one signal to said display.

11. The device of claim 10, further comprising a controller configured to send at least a portion of said image data to said driver circuit.

12. The device of claim 9, further comprising an image source module configured to send said image data to said processor.

13. The device of claim 12, wherein said image source module comprises at least one of a receiver, transceiver, and transmitter.

14. The device of claim 9, further comprising an input device configured to receive input data and to communicate said input data to said processor.

15. A display device comprising:
means for displaying image data; and
means for demultiplexing one or more row driving voltages and providing demultiplexed voltages to said displaying means.

16. The device of claim 15, wherein said displaying means comprises one or more MEMS display elements.

17. A method of making a display device, the method comprising:
forming an array of microelectromechanical system (MEMS) display elements on a substrate; and
forming a plurality of passive impedance network circuits coupled to said array and configured to provide row output voltages to drive said array, each passive impedance network comprising an output to a row of display elements and three or more inputs, wherein for each passive impedance network the output is controlled by the three or more inputs, and wherein each input is at one of two pre-determined voltages.

18. The method of claim 17, wherein one of the pre-determined voltages is ground.

19. A method of making a display device, the method comprising:
forming an array of microelectromechanical system (MEMS) display elements on a substrate; and
forming a plurality of passive impedance network circuits coupled to said array and configured to provide row output voltages to drive said array, each passive impedance network comprising an output to a row of display elements and three or more inputs,
wherein the plurality of passive impedance network circuits are connected to each other in a manner such that each passive impedance network circuit shares no more than one input with any other passive impedance network circuit.

20. A method of demultiplexing a row driving voltage in a row by row addressing scheme of a display device, said method comprising:
applying a first control voltage to a first set of output nodes including a selected output node through a first set of series impedances;
applying a second control voltage to a second set of output nodes through a second set of series impedances, said second set including said selected output node and not including any other output nodes of said first set; and
applying a third control voltage to a third set of output nodes through a third set of series impedances, said third set including said selected output node and not including any other output nodes of said first set or said second set.

21. The method of claim 20, wherein said control voltages are substantially equal.

22. The method of claim 21, wherein said series impedances are substantially equal.
